(19) United States
(12) Patent Application Publication
(10) Pub. No.: US 2020/0198010 A1
(43) Pub. Date: Jun. 25, 2020

(54) METHOD AND DEVICE FOR ADDITIVE PRODUCTION OF AT LEAST ONE COMPONENT LAYER OF A COMPONENT, AND STORAGE MEDIUM

(71) Applicants: EOS GmbH Electro Optical Systems, Krailling (DE); MTU Aero Engines AG, München (DE)

(72) Inventors: Sebastian EDELHÄUSER, Zorneding (DE); Martin LEUTERER, Olching (DE); Michael GÖTH, München (DE); Bernd BIECHELE, Gilching (DE); Markus FROHNMAIER, Hengersberg (DE); Gerd CANTZLER, Neuried (DE); Johannes CASPER, München (DE)

(73) Assignees: EOS GmbH Electro Optical Systems, Krailling (DE); MTU Aero Engines AG, München (DE)

(21) Appl. No.: 16/639,227

(22) PCT Filed: Jul. 27, 2018
(86) PCT No.: PCT/EP2018/070482

§ 371 Date: Feb. 14, 2020

(30) Foreign Application Priority Data
Aug. 17, 2017 (DE) 10 2017 118 831.2

(51) Int. Cl. B22F 3/105

(52) U.S. Cl. CPC B22F 3/1055; B22F 2003/1057; B33Y 10/00; B22F 2998/10; B22F 2203/11

(57) ABSTRACT

The invention relates to a method for additive production of a component layer of a component including the steps of: generating at least one layer from a powdery component material in the region of a structuring and joining zone; subdividing model data of the layer into virtual sub-regions by a control device; selecting at least one of the virtual sub-regions by the control device; localized heating of at least one heating region in a real sub-region of the layer corresponding with the selected virtual sub-region by a heating device; verifying whether a temperature of the layer has, in a predetermined inspection region, a predetermined minimum temperature; and localized solidifying of the layer in a predetermined solidifying region by selective irradiation by at least one energy beam of an energy source, if the layer has the predetermined minimum temperature in the inspection region.

The invention relates to a method and a device for additive production of at least one component layer of a component as well as to a storage medium with a program code for controlling such a device.

In so-called additive and generative manufacturing methods (so-called additive manufacturing and rapid prototyping methods, respectively), respectively, a component region and a complete component, respectively, which can for example be a component of a fluid kinetic machine and an aircraft engine, respectively, is structured in layers. Predominantly metallic components are usually produced by laser and electron beam melting or sintering methods, respectively. Therein, at least one powdery component material is first applied in layers in the region of a structuring and joining zone to form a layer. Subsequently, the component material is locally solidified by supplying energy to the component material in the region of the structuring and joining zone by means of at least one energy beam, whereby the component material melts or sinters and forms a component layer. Therein, the energy beam is controlled depending on layer information of the component layer respectively to be produced. The layer information is usually generated from a 3D CAD body of the component and subdivided into individual component layers. After solidification of the molten component material, the component platform is lowered in layers by a predefined layer thickness. Thereafter, the mentioned steps are repeated until final completion of the desired component region or the entire component. Therein, the component region and the component, respectively, can basically be produced on a component platform or on an already generated part of the component or component region or on a support structure. The advantages of this additive manufacture are in particular in the possibility of being able to produce very complex component geometries with cavities, undercuts and the like within the scope of a single method.

For increasing the component quality, it is known that the powder bed is heated by means of a heating device to facilitate melting and sintering of the component material and to reduce stresses in the solidified material and prevent undesired structure defects or other defects. Besides approaches of global heating of the powder bed, in some circumstances, it can be more efficient that an area of the powder bed or of a component heatable at an identical point of time only occupies a small portion of a construction field or of the component. Then, the heating region optionally has to be moved across the construction field in order that an entire component cross-section can be irradiated. However, a scanning speed of the energy beam used for solidifying (laser, electron beam) is usually relatively high at the same time. In addition, an action field of the energy beam on the powder bed can include jumps or large distances between individual solidifying regions, which are traveled in very short time (e.g. with contour exposure, island irradiation strategy etc.). Depending on the selected heating device, displacement of the heating region can be substantially slower effected in contrast for mechanical and thermal reasons. This makes the additive manufacture of components inefficient and increases the likelihood of reduced component qualities.

It is the object of the present invention to specify a method and a device, which allow process-reliable additive production of component layers of a component. A further object of the invention is in specifying a storage medium with a program code, which ensures a corresponding control of such a device.

According to the invention, the objects are solved by a method comprising the features of claim 1, a device comprising the features of claim 14 as well as by a storage medium according to claim 15. Advantageous configurations with convenient developments of the invention are specified in the dependent claims, wherein advantageous configurations of each inventive aspect are to be regarded as advantageous configurations of the respectively other inventive aspect.

A first aspect of the invention relates to a method for additive production of at least one component layer of a component. A process-reliable additive production of component layers and thereby an optimization of the component quality is achieved according to the invention in that at least the steps of a) generating at least one layer from a powdery component material in the region of a structuring and joining zone, b) subdividing model data of the layer into virtual sub-regions by means of a control device, c) selecting at least one of the virtual sub-regions by means of the control device, d) locally heating at least one heating region in a real sub-region of the layer corresponding to the selected virtual sub-region by means of a heating device, e) verifying if a temperature of the layer has a predetermined minimum temperature at least in a predetermined inspection region, and f) locally solidifying the layer at least in a predetermined solidifying region by selectively irradiating by means of at least one energy beam of an energy source if the layer has at least the predetermined minimum temperature in the inspection region, are performed.

Therein, the invention is based on the realization that only those regions of the layer should be selectively irradiated for high process reliability, which reach or have reached at least a predefined minimum or set temperature before and/or during the irradiation (approved inspection region or approval region). However, a heating or sub-region of the layer heated at least to the minimum or set temperature at a certain point of time only occupies a relatively small portion of the overall area of the structuring and joining zone and of the component layer to be produced, respectively, due to the locally limited effect of the heating device within the scope of the present invention. Thus, “local” denotes a certain region of the structuring and joining zone with a surface area, which is less than a surface area of the entire structuring and joining zone, in particular less than 50%. In other words, the present heating device is not formed and/or controlled to simultaneously heat an entire layer or the entire work plane in the structuring and joining zone, which is also referred to as construction field, to the minimum temperature. Considering the different speeds of “heating” and “irradiation”, therefore, model data representing a representation of the layer is first subdivided into two or more virtual sub-regions or segments according to the invention. Therein, the model data can basically represent a two- and/or three-dimensional region of the layer, i.e. only a surface of the layer as a part of a work plane or additionally a depth extension of the layer. Subsequently, at least one of the virtual sub-regions is selected and a heating region in at least one real sub-region is heated, wherein the at least one real sub-region corresponds to the selected virtual sub-region or sub-regions. The term “correspond” basically expresses a defined association and can mean that a virtual and a real sub-region correspond to each other with respect to their surface area and/or their volume and/or their configuration and/or their position relative to a coordinate system of the structuring and joining zone and relative to the component layer to be produced, respectively, if the model data forms a correct representation of the physics. Therein, heating and tempering, respectively, of a part of the layer or already previously solidified layer or component regions to a temperature above a respectively current ambient temperature in the structuring and joining zone and below the melting or sintering temperature of the currently used component material before fusing the component material is presently understood by “heating”, while heating of the component material to a temperature above its respective melting or sintering temperature with the aid of the energy source or an irradiation device is understood by “irradiation” or “exposure”. Alternatively to capturing or verifying or evaluating measured, extrapolated or otherwise determined temperatures or temperature values, it can also be sufficient to respectively use a quantity physically representing the temperature thereto. The layer itself can basically be applied all over or only selectively to the structuring and joining zone per layer application. Basically, the heating device is not restricted to a certain type and can for example be a laser or electron beam, the area of impingement of which on the construction field is larger than that of the energy beam used for solidification. The virtual/real sub-regions basically characterize and include, respectively, regions of the respectively uppermost layer at least relevant to the current construction task, but can also be determined considering a depth extension of the heating as needed and for example include 1, 2, 3, 4, 5, 6, 7, 8, 9, 10 or more subjacent layers and already partially or completely solidified component regions, respectively. The model data and the virtual sub-regions determined therefrom, respectively, and thereby also their corresponding real sub-regions can be, but do not compulsorily have to be geometrically contiguous, and can, but do not compulsorily have to contain the component layer respectively to be produced, respectively, but can also characterize regions of the layer, which for example belong to support structures or to other components. Furthermore, each virtual sub-region can basically be locally and/or temporally predetermined or dynamically ascertained and adapted, respectively, for example considering current construction data. The same applies to the heating, inspection and solidifying regions, which can basically also be predetermined in the model data and/or dynamically ascertained depending on or independently of each other. In the following, both a virtual and a corresponding real sub-region are understood by the term “sub-region”, if it is not specifically spoken of a virtual or a real sub-region. Therein, statements to virtual sub-regions relate to the underlying model data, while the statements to real sub-regions relate to the non-solidified or partially or completely solidified layer. Therein, a sub-region can basically correspond to a defined solidifying region and/or a cross-sectional area of a component and/or a partial area of an entire construction field. However, the (virtual/real) sub-regions are generally not restricted with respect to their geometry. In case of an irradiation speed higher with respect to the heating, it can be provided that the real sub-regions, which should reach or exceed the requested minimum temperature at the same time or one after the other, are several or many times larger than an area of impingement of the energy beam in the focused state on the component material since an irradiation procedure otherwise is only possible severely slowed or has to be interrupted each time an approved inspection region is solidified. Subsequently, a first virtual sub-region is selected and tempering of the heating region in the real sub-region of the layer corresponding to the virtual sub-region is started. Thus, the irradiation of the concerned real sub-region of the layer is only approved if the inspection region associated with the real sub-region has reached the requested minimum temperature. Therein, it can basically also be provided that the sub-region is heated above the minimum temperature to better consider possible thermal conducting and cooling effects between the steps of “heating” (step d)) and “solidifying” (step f)). Similarly, it can be provided that identical or different maximum temperatures are predetermined for some or all of the heating regions such that a temperature sufficient for approval of the irradiation can be between the minimum temperature and the maximum temperature. Thereby, global and/or local temperature ranges (temperature corridors/temperature bands) can be defined. Preferably, a homogeneity of heating within the respective inspection regions and in comparison to multiple inspection regions approved for solidification is verified and ensured by a regulating mechanism. Thus, the principle of the inspection regions can be extended. A temperature band, in which a solidification is permitted, can be supplemented or dynamically adapted by a narrower temperature band and corresponding minimum and maximum temperature values, respectively, which represent a preferred range to achieve improved material characteristics. By the criterion “temperature”, the criterion “time” can optionally also be verified, that is it is verified in step e) how long an inspection region is already maintained in a preferred temperature range at the actual or planned point of time of the solidification. By this interaction and coordination, respectively, of the steps of “heating” and “irradiating”, it is therefore possible to process-reliably solidify a component layer in a time as short as possible and as continuously as possible, whereby a correspondingly high component quality is achieved. Furthermore, it can be provided that the steps a) to f) are repeated one or multiple times, preferably until completion of a component region or the entire component. Similarly, it can be provided that the order of two or more of the steps a) to f) is varied or that two or more of the steps a) to f) are executed at the same time for different sub-regions. Furthermore, “a/an” is generally to be read as indefinite article within the scope of this disclosure, thus always also as “at least one” without expressly opposite specification. Inversely, “a/an” can also be understood as “only one”.

In an advantageous configuration of the invention, it is provided that the heating device selectively heats a partial volume of an overall volume of the powdery component material in a construction container to the predetermined minimum temperature at a point of time, wherein the partial volume includes at least 0.01%, preferably at least 0.1%, particularly preferably at least 1% and/or at most 50%, preferably at most 30%, particularly preferably at most 10% of a surface area of a work plane in the structuring and joining zone. In other words, the heating device is formed to selectively heat only a partial volume of for example 0.01%, 0.02%, 0.03%, 0.04%, 0.05%, 0.06%, 0.07%, 0.08%, 0.09%, 0.10%, 0.2%, 0.3%, 0.4%, 0.5%, 0.6%, 0.7%, 0.8%, 0.9%, 1.0%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% or 50% of the construction field or a surface area of a work plane in the structuring and joining zone. In contrast to global heating, selective heating means that the part of the overall volume located outside of the partial volume is not heated or at least remains below the predetermined minimum temperature. The overall volume of the construction container is variable during a layer-based production method since its depth (“z-direction”) is depending on the number of already applied layers. Therein, the structuring and joining zone can be regarded as a section from a two-dimensional work plane of the energy beam, wherein the structuring and joining zone represents at least a surface of an applied and/or partially or completely solidified layer of the powdery component material. Thus, the heated partial volume has at least a portion of a surface, i.e. of an uppermost applied layer. The depth extension of the partial volume starting from the surface can basically be arbitrarily defined or preset and is typically at least adapted to a depth extension of a solidification process in a z-direction perpendicular to the structuring and joining zone or work plane. The heating of the partial volume to the predetermined minimum temperature by the heating device is generally not compulsorily effected as direct or immediate heating, but can also be effected indirectly by a propagation of heat from an origin into surrounding regions according to the principles of thermal transfer. Preferably, an effective range of the heating device and the structuring and joining zone are generally movable relative to each other in order that an entire layer or the entire surface area of a work plane in the structuring and joining zone can be heated to the predetermined minimum temperature at least in a temporal progression on demand.

In a further advantageous configuration of the invention, it is provided that the model data is subdivided into two-dimensional and/or three-dimensional virtual sub-regions and/or that the model data characterizes the work plane of the energy beam on the layer. For example, virtual sub-regions can be set in that the structuring and joining zone or that the layer is rasterized into identically sized and regular fields, respectively. Thereby, the virtual sub-regions can for example be defined as polygons such as squares, rectangles or hexagons. It is understood that the corresponding real sub-regions are basically three-dimensional and for example have at least the same height as the uppermost layer even if the virtual sub-regions are only two-dimensionally defined. However, the model data does not compulsorily have to characterize the entire area of the structuring and joining zone, but can also characterize only a work plane or a component cross-section, for example the region of the uppermost layer to be solidified.

In a further advantageous configuration of the invention, it is provided that at least two regions of the group of real sub-region, heating region, inspection region and solidifying region are at least substantially identically selected. In other words, two, three or four regions of the mentioned group are identical or at least 90% or more identical, at least with respect to their two-dimensional extension in a top view to the structuring and joining zone or the construction field. For example, the real sub-region and the inspection region and/or the real sub-region and the solidifying region can be identical or virtually identical. Alternatively or additionally, it is provided that at least one region of the group of real sub-region, heating region, inspection region and solidifying region is a subset and/or an intersecting set of another region of this group. In other words, at least one of the mentioned regions can be located completely within another region and form a subset of the other region. For example, the heating region and/or the inspection region can be a subset of the real sub-region. Inversely, the sub-region can also be a subset of the heating region. This is the case if the heated area of the heating region is larger than the area of the corresponding sub-region. This accounts for the fact that the pre-heating often cannot be exactly tailored or restricted to an area and geometry of a certain sub-region, respectively, depending on the used heating device. Moreover, heating of the layer can generally also be indirectly effected, for example via the heating of an adjacent, underlying, already fused and/or already solidified region, from which heat then diffuses in the layer located besides and/or above. Similarly, at least one of the mentioned regions can be partially outside of another region and thereby form an intersecting set with the other region. For example, the heating region can be partially outside of the real sub-region such that an adjacent further sub-region is also co-heated. Furthermore, it can alternatively or additionally be provided that at least two procedurally consecutive regions of the group of real sub-region, heating region, inspection region and solidifying region overlap. For example, procedurally or temporally consecutive inspection regions can overlap each other such that certain sections of multiple real sub-regions are inspected several times. This can in particular be reasonable with comparatively large-area sub-regions to better control thermal conducting effects.

In a further advantageous configuration of the invention, it is provided that a metal-based component material is used, which is composed of a metal and/or a metal alloy and/or the precipitations thereof, in particular of a difficultly weldable metal and/or a difficultly weldable metal alloy at least to 50% by vol., that is for example to 50% by vol., 51% by vol., 52% by vol., 53% by vol., 54% by vol., 55% by vol., 56% by vol., 57% by vol., 58% by vol., 59% by vol., 60% by vol., 61% by vol., 62% by vol., 63% by vol., 64% by vol., 65% by vol., 66% by vol., 67% by vol., 68% by vol., 69% by vol., 70% by vol., 71% by vol., 72% by vol., 73% by vol., 74% by vol., 75% by vol., 76% by vol., 77% by vol., 78% by vol., 79% by vol., 80% by vol., 81% by vol., 82% by vol., 83% by vol., 84% by vol., 85% by vol., 86% by vol., 87% by vol., 88% by vol., 89% by vol., 90% by vol., 91% by vol., 92% by vol., 93% by vol., 94% by vol., 95% by vol., 96% by vol., 97% by vol., 98% by vol., 99% by vol. or 100% by vol. For example, the component material can be composed of a nickel- or cobalt-based super alloy, of a titanium aluminide, of a metal matrix composite, of a metallic glass or the like to at least 50% by vol. Alternatively or additionally, it is provided that a powdery component material is used, which contains one or more of the group of particles, whiskers and fibers.

In a further advantageous configuration of the invention, it is provided that the heating region is heated to a minimum temperature of 400° C. or more and/or to a maximum temperature of 3500° C. or less and/or the minimum temperature is at least 50% of the melting temperature in ° C. of a currently used component material. For example, minimum temperatures of 400° C., 450° C., 500° C., 550° C., 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., 1550° C., 1600° C., 1650° C., 1700° C., 1750° C., 1800° C., 1850° C., 1900° C., 1950° C., 2000° C., 2050° C., 2100° C., 2150° C., 2200° C., 2250° C., 2300° C., 2350° C., 2400° C., 2450° C., 2500° C., 2550° C., 2600° C., 2650° C., 2700° C., 2750° C., 2800° C., 2850° C., 2900° C., 2950° C., 3000° C., 3050° C., 3100° C., 3150° C., 3200° C., 3250° C., 3300° C., 3350° C., 3400° C., 3450° C., 3500° C. or more are understood by a minimum temperature of at least 400° C., wherein corresponding intermediate values such as for instance 700° C., 701° C., 702° C., 703° C., 704° C., 705° C., 706° C., 707° C., 708° C., 709° C., 710° C., 711° C., 712° C., 713° C., 714° C., 715° C., 716° C., 717° C., 718° C., 719° C., 720° C. etc. are to be regarded as also disclosed. In particular, temperatures of 3500° C., 3450° C., 3400° C., 3350° C., 3300° C., 3250° C., 3200° C., 3150° C., 3100° C., 3050° C., 3000° C., 2950° C., 2900° C., 2850° C., 2800° C., 2750° C., 2700° C., 2650° C., 2600° C., 2550° C., 2500° C., 2450° C., 2400° C., 2350° C., 2300° C., 2250° C., 2200° C., 2150° C., 2100° C., 2050° C., 2000° C., 1950° C., 1900° C., 1850° C., 1800° C., 1750° C., 1700° C., 1650° C., 1600° C., 1550° C., 1500° C., 1450° C., 1400° C., 1350° C., 1300° C., 1250° C., 1200° C., 1150° C., 1100° C., 1050° C., 1000° C., 950° C., 900° C., 850° C., 800° C., 750° C., 700° C., 650° C., 600° C., 550° C., 500° C., 450° C., 400° C. or less are to be understood by a maximum temperature of 3500° C., wherein corresponding intermediate values are also to be regarded as also disclosed here too. Alternatively or additionally, the minimum temperature can be at least 50% of the melting temperature measured in ° C. of a currently used component material. If the melting temperature is for example at 1000° C., the minimum temperature can be 500° C. or more. Of course, a maximum temperature is generally always above a minimum temperature. Exact values for the temperature(s) of a heating region can for example also be selected depending on certain phase transition temperature thresholds with a metal-based component material.

In a further advantageous configuration of the invention, it is provided that at least the steps c) to f) are performed for two or more sub-regions, in particular for all of the sub-regions of the layer to be solidified. Hereby, it can be ensured for a predominant part or for the entire component layer to be produced that an irradiation only occurs if the powdery component material has the requested minimum temperature in the region to be irradiated, whereby a correspondingly high component quality is achieved. Hereto, the production of the component layer can for example be effected in sequential or stepped or successive manner such that a first heating or sub-region of the powder bed to be solidified is first heated and irradiated after reaching the minimum temperature. After irradiating the first sub-region, the heating device or its heating region is then displaced to a subsequent sub-region and the subsequent sub-region is irradiated after reaching the minimum temperature and so on. In other words, it can be provided that each sub-region to be solidified is first directly or indirectly heated and is solidified after reaching the minimum temperature one after the other, whereupon the heating device heats the temporally or procedurally subsequent sub-region and so on.

Further advantages arise in that sub-regions temporally subsequent to each other are selected by means of the control device such that the sub-regions spatially adjoin to each other or are spatially separated from each other. In other words, it is provided that sub-regions to be heated and to be irradiated temporally or procedurally one after the other are selected such that they spatially adjoin to each other, whereby a continuous or at least quasi-continuous strip irradiation over a larger contiguous region or preferably over the entire region of the layer to be irradiated is possible. Therein, the corresponding virtual sub-regions do not compulsorily have to be three-dimensionally formed, but can also only be present as two-dimensional areas, which contact each other at a point or along a line. With multiple sub-regions adjoining to each other, the respectively different size of a common interface or the respective length of a common boundary line can for example be the criterion for a determination of the order. Thus, that sub-region with the longest common boundary line (x/y plane) to a preceding sub-region can for example be determined as a first subsequent sub-region. Alternatively, sub-regions to be heated and irradiated temporally or procedurally one after the other can be selected such that they are spatially not contiguous, but spaced from each other. Hereby, a sufficient pre-heating can also be ensured for non-contiguous regions of the layer such that component layers with gaps or construction tasks, in which multiple components are to be manufactured at the same time etc. can also be processed in particularly reliable and high-quality manner. The definition and ascertainment, respectively, of minimum and/or maximum distances between individual virtual and thereby real sub-regions can for example be effected depending on a component geometry, a distribution of multiple components to be produced within a construction task in the structuring and joining zone, in cross-sections in a construction volume of a production device and the like.

In a further advantageous configuration of the invention, it is provided that at least one of the steps c) to e) is performed during step f) for at least one further sub-region. In other words, it is provided that during the local solidification of a sub-region, it is already begun to select a sub-region to be subsequently processed and optionally already to heat the corresponding heating region. Hereby, the production method can be further accelerated since after solidifying a sub-region, the energy beam can continue with the solidification of the subsequent and ideally already correctly tempered sub-region with low delay or even without delay.

In a further advantageous configuration of the invention, it is provided that the layer is heated in the heating region of the further sub-region such that the heating region of the further sub-region has at least the predetermined minimum temperature as soon as the irradiation of the preceding sub-region is completed. Thereby, a continuous or at least predominantly continuous solidification and scanning of the component material by the energy beam (e.g. along a strip) is allowed, respectively, since the steps of “heating” and “irradiating” are temporally coordinated such that irradiation breaks as low as possible and preferably no irradiation breaks occur between temporally consecutive sub-regions. Within the scope of the present disclosure, a period of time is in particular understood by an irradiation break, in which the layer is not locally irradiated and solidified, respectively, and the energy beam is deactivated, respectively, because e.g. the heating device first has to move to a target position to heat a (further) sub-region there, or because e.g. during heating a sub-region, a desired minimum temperature has not yet been reached. In contrast, within the scope of the present disclosure, possible short irradiation breaks, which e.g. are taken in the typical irradiation pattern of hatching between sweeping or scanning of individual lines substantially parallel to each other, if a beam deflection unit performs a reversal operation without the beam being activated therein, do not come within the term “irradiation break”.

In a further advantageous configuration of the invention, it is provided that step f) is only performed for the first time for the layer if at least a predetermined minimum number of sub-regions has been selected and the associated heating regions have been heated to their respectively predetermined minimum temperature. In this manner, a buffer or a minimum pre-run of heating regions or pre-heated sub-regions can be generated such that an irradiation does not have to be terminated after approval of a sub-region or segment, but can be continued in a next approved sub-region without delay (“rolling approval”). Preferably, the minimum number is set such that a solidification of the entire component layer as low in interruptions as possible or without interruptions is possible, that is that the buffer of pre-heated sub-regions is not consumed before termination of the solidification.

In a further configuration of the invention, a minimum pre-run of heating regions is selected depending on the current position of the energy beam on the layer. Hereby, a respectively optimum minimum pre-run for the heating of the respective heating regions or the sub-regions to be pre-heated can be dynamically ascertained or determined adapted to situation.

In a further configuration of the invention, a minimum post-run of heating regions is set depending on the current position of the energy beam on the layer. Hereby, a minimum post-run of heating regions or heated sub-regions can be dynamically ascertained or determined adapted to situation.

In a further advantageous configuration of the invention, it is provided that at least one further sub-region is selected by means of the control device and a heating region associated with the sub-region is heated by means of the heating device if a predetermined maximum number of solidified sub-regions and/or sub-regions heated to their respectively predetermined minimum temperature has been reached or exceeded. This allows the definition of a maximum number of irradiated and approved sub-regions or segments, respectively, before the heating region of the heating device is displaced. Hereby, a buffer can also be provided such that the heating region of the heating device is displaced in time such that a sufficient number of approved (i.e. sufficiently heated) sub-regions or segments is always available.

Basically, it can be provided that a ratio of “minimum number:maximum number” and “minimum pre-run:minimum post-run”, respectively, is set between 10:1 and 1:10, thus for example 10:1, 9:1, 8:1, 7:1, 6:1, 5:1, 4:1, 3:1, 2:1, 1:1 or 1:10, 1:9, 1:8, 1:7, 1:6, 1:5, 1:4, 1:3, 1:2 or 1:1. Alternatively to a local definition of the ratio of minimum pre-run to minimum post-run over sub-regions or heating regions, a temporal definition with the mentioned range can analogously also be selected. For instance, if an overall dwelling time of a location of the structuring and joining zone in an effective range of a moved heating device, which allows heating to the predetermined minimum temperature, is a period of time x, thus, for example with a selected temporal ratio of 2:3 (minimum pre-run:minimum post-run), the period of time of the minimum pre-run is two fifth of the difference of x and that time, which is required for the solidification of the solidifying region. A ratio particularly beneficial in the concrete case of application of “minimum number:maximum number” and “minimum pre-run:minimum post-run”, respectively, can be ascertained in a test method or in a simulation, e.g. depending on specific requirements to the processing of a selected component material. A thus ascertained ratio can serve to specifically influence the microstructure of a component and to improve its mechanical characteristics, respectively.

In a further advantageous configuration of the invention, it is provided that the control device predetermines and/or ascertains and/or adapts during the method at least one parameter of the group of material characteristic of the component material, capturing frequency of a thermography device for temperature ascertainment of inspection regions, number of the sub-regions, geometry of the sub-regions, surface area of the sub-regions, length of the sub-regions, width of the sub-regions, distance of adjacent sub-regions, irradiation type and pattern, respectively, of the sub-regions, irradiation duration of the sub-regions, processing order of the sub-regions, minimum temperature of the sub-regions, actual temperature of the sub-regions, movement path of the heating device across the layer, movement path of the energy beam across the layer, area of the layer heatable by the heating device, location of impingement of the energy beam on the layer, area of the energy beam on the layer and irradiation speed of the energy beam. In that the control device is formed to perform one or more of the mentioned steps, an optimum control and regulation of the production method are allowed, respectively.

Further advantages arise in that the control device controls and/or regulates the heating device and the energy source depending on each other. This configuration of the control device allows heating and irradiating the powder bed as low in interruptions as possible or without interruption since coupling of the movement of the heating spot of the heating device or the heating region to a direction and speed of an irradiation progress of the energy beam, respectively, and/or to an energy input into the heating region can occur. In this manner, travel paths or movement paths of the heating device as efficient as possible with regard to the overall area of the component layer to be irradiated and the respective irradiation strategy for the individual sub-regions are achieved.

In a further advantageous configuration of the invention, it is provided that the control device controls and/or regulates the heating device such that the energy beam can be moved over all of the sub-regions or the layer to be solidified with constant or varying feed speed in uninterrupted or at least predominantly uninterrupted manner. In other words, the control and/or regulation of the heating device and the energy source are effected such that the energy beam possibly rarely and preferably never “breaks” or has to be interrupted or turned off, but can be passed across the entire area of the layer to be solidified with a feed speed as constant as possible. Hereby, a particularly high component quality can be ensured since joint regions between adjoining sub-regions due to the “break” of the energy beam do not occur. Such interruptions primarily arise in that the heating region is displaced over a distance, which is longer than the extension of an effective range allows, which allows reaching the minimum temperature. Thus, the number and distance of “large” jumps between defined exposure fields are to be reduced. Therefore, the so-called hatch reversal at each hatch end is not understood as breaking or interrupting in terms of the present disclosure, which is usually effected with the energy beam turned off, but does not result in an appreciable or inadmissible cooling of the powder bed in the concerned solidifying region. Accordingly, breaking or interrupting in terms of the present disclosure is usually associated with an inadmissible temperature change of the powder bed, whereby a reliable and process-reliable solidification is not yet or no longer possible. Preferably, “predominantly uninterrupted” within the scope of the present disclosure means that the irradiation duration on average is at least 50%, thus for example 50%, 51%, 52, %, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89% or 90% of the layer processing duration measured from the start up to the final point of time of the irradiation of a layer or at least a cross-section. Preferably, irradiation durations of at least 91%, thus of 91%, 92%, 93%, 94%, 95%, 96%, 97%, 98%, 99% or 100% of the layer processing duration are to be understood by “uninterrupted”.

Further advantages arise in that the solidifying region is heated by means of the heating device during and/or after step f). Hereby, it is possible on demand to keep the temperature of the layer at least at the desired minimum temperature or to bring it to a temperature deviating from the minimum temperature during the solidification.

Similarly, it can be provided that the heating of the solidifying region by means of the heating device is aborted before, during or after step f) or reduced with respect to heating in step d). Hereby, the heating device can be moved to a heating region to be temporally or procedurally subsequently heated before, during or after solidification of the solidifying region, whereby corresponding gains in time can be realized. After “approval” of a correctly tempered or already solidified solidifying region or segment, the heating region can be displaced by a required distance such that at least one further heating region is in a distance and orientation to the heating device, respectively, which allows/allow heating to the minimum or set temperature value. As a result of the comparatively high local energy input of the energy beam in solidification too, it can be provided that the energy input by the heating device is set to a level below an energy input during step d) during the solidification (i.e. during step f)), in order that overheating of the component material and thereby inadmissible exceeding of both a minimum and a maximum temperature does not occur in the locally and temporally cumulated energy input from two different energy sources (heating device and energy beam). In other words, the layer is less severely heated by means of the heating device in the solidifying region during solidification than before and/or after solidification in a configuration of the invention, which would result in a lower temperature without the additional energy input by the energy beam, but overall results in a temperature due to the addition of both energy inputs, which allows at least fusing or sintering the component material.

Further advantages arise in that a minimum temperature and/or a maximum temperature and/or a predetermined temperature progression of the sub-region is/are preset and/or determined depending on an area and/or a geometry of the solidifying region, that is the component cross-section or section or sub-region of the component cross-section to be solidified or being solidified. Hereby, a type of “temperature corridor” can be statically preset and/or dynamically determined such that an energy input by the heating device and/or by the energy beam, i.e. e.g. the powers and movement speeds thereof, is or are controlled and regulated, respectively, depending on the temperature of the inspection region, which is measured at least in a section of a sub-region, and depending on a quantity physically representing the temperature in the inspection region, respectively. Hereby, the temperature progression can also be temporally correlated. For example, a temperature band located lower can be selected for delicate cross-sections than for cross-sections, which are configured extensively uninterrupted. This allows a particularly process-reliable solidification of components of different configuration.

Further advantages arise if a predetermined minimum temperature and/or a predetermined maximum temperature or a predetermined temperature progression are selected for a number of inspection regions and/or solidifying regions respectively depending on an area and/or a geometry and/or a sought microstructure of a component cross-section or section of the component cross-section to be solidified or bring solidified, wherein the minimum temperature and/or the maximum temperature and/or the temperature progression is or are preferably separately set for each inspection region and/or solidifying region. By corresponding control and regulation of the heating device, respectively, a predetermined temperature progression with corresponding set temperatures can be generated, wherein the number of inspection regions and/or solidifying regions can basically be 1, 2, 3, 4, 5, 6, 7, 8, 9 or more. In this manner, a desired microstructure and thereby an optimum structure quality and/or crystal lattice structure can be specifically generated.

In a further advantageous configuration of the invention, it is provided that the heating region is heated by means of the heating device with a deviating heating rate if the temperature of the layer in the predetermined inspection region does not have the predetermined minimum temperature. Hereby, an advantageous regulation of the temporal temperature change of the layer can be realized.

Further advantages arise in that the control device controls and/or regulates the heating device such that an already locally solidified sub-region has at least a predetermined minimum temperature and/or at most a predetermined maximum temperature. This allows controlled heating after solidification for reducing a likelihood of the occurrence of hot cracks as well as improved static or dynamic control and regulation of the heating device, respectively, whereby correspondingly high component qualities are realizable. Preferably, a predetermined maximum temperature is not exceeded within the sub-region before, during and/or after step f). It is also possible to ensure a heat treatment or a preferably controlled cooling of the solidified sub-region optionally after the solidification to achieve a particularly high structure quality. If the temperature in the solidified sub-region cannot or not directly be measured, a temperature prediction can also be used instead of the temperature. Preferably, a maximum difference between the minimum and the maximum temperature is at most 300 K, thus for example 300 K, 290 K, 280 K, 270 K, 260 K, 250 K, 240 K, 230 K, 220 K, 210 K, 200 K, 190 K, 180 K, 170 K, 160 K, 150 K, 140 K, 130 K, 120 K, 110 K, 100 K, 90 K, 80 K, 70 K, 60 K, 50 K, 40 K, 30 K, 20 K, 10 K or less.

Further advantages arise in that a predetermined minimum temperature and/or a predetermined maximum temperature is or are selected the lower the longer the solidification dates back in temporally and/or procedurally consecutively solidified sub-regions. This allows controlled decrease of a temperature of an already solidified real sub-region to limit temperature gradients arising upon a transition to lower temperatures, e.g. outside of an effective range of the heating device, and thus to further reduce a likelihood of the occurrence of hot cracks.

In a further advantageous configuration of the invention, it is provided that a reference location of a heating region of the heating device and/or a solidifying region or irradiation region of the energy beams are determined by means of the control device and used for controlling and/or regulating a relative movement of the heating device and energy beam to each other. A reference location can basically be positioned in any number and at any suitable real or virtual locations. For example, the heating device and the energy beam can each have a reference location, e.g. a light spot or another marking, the relative movement of which can be tracked camera-based and from which control commands for controlling the movement path of the heating device and the energy beam are derived, respectively. Analogously, representations calculated at the level of machine control data and software representations, respectively, of a heating region and an irradiation region can be correlated with each other to determine the reference location. Hereto, the control device can for example perform a calculation of x/y control coordinates, whereto central points of a regularly or irregularly shaped heating region and a regularly or irregularly shaped irradiation region, respectively, can be used as reference locations.

In a further advantageous configuration of the invention, it is provided that a relative movement of the heating region of the heating device and the solidified sub-region by a distance and/or in a direction, by which the sub-region leaves a maximum effective range of the heating device, which allows heating the sub-region to a temperature value of at least 1000° C., thus for example of 1000° C., 1020° C., 1040° C., 1060° C., 1080° C., 1100° C., 1120° C., 1140° C., 1160° C., 1180° C., 1200° C., 1220° C., 1240° C., 1260° C., 1280° C., 1300° C., 1320° C., 1340° C., 1360° C., 1380° C., 1400° C., 1420° C., 1440° C., 1460° C., 1480° C., 1500° C. or more and/or of at least 70%, thus for example of 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99% of the melting temperature in ° C. of the currently used component material, is effected depending on a positive verification to the effect whether the temperature of at least a predetermined section of the solidified sub-region corresponds to the preset temperature progression and at most to the predetermined maximum temperature, respectively. Since the risk of a possible hot crack formation is higher after solidification in some cases than during or before solidification, this criterion can have priority over other competing criteria, for example over the beginning of the solidification of a region approved for solidification. Thereby, it even can obtain a higher rank than an irradiation as continuous as possible. Besides approval for irradiation, a further approval for displacing the heating region can hereby be realized. Therein, the verification can be effected by measurement and/or projection or simulation of the temperature values, which is for example reasonable in cases, in which an immediate temperature measurement is not possible for example due to shadings by other equipment parts.

A second aspect of the invention relates to a device for additive production of at least one component layer of a component, in particular of a component of a fluid kinetic machine, wherein the device comprises at least one coater for generating at least one layer from a powdery component material in the region of a structuring and joining zone, at least one energy source for generating at least one energy beam, by means of which the layer can be solidified locally to the component layer in the region of the structuring and joining zone, at least one heating device, by means of which the layer can be locally heated, and at least one inspection device, by means of which a temperature of the layer can be verified. A process-reliable additive production of component layers and thereby an optimization of the component quality is achieved according to the invention in that the device includes a control device, which is configured to subdivide model data of the structuring and joining zone into virtual sub-regions, to select at least one of the virtual sub-regions, to locally heat at least one heating region in a real sub-region of the layer corresponding to the selected virtual sub-region by means of the heating device, to verify by means of the inspection device if a temperature of the layer has a predetermined minimum temperature at least in a predetermined inspection region and to locally solidify the layer at least in a predetermined solidifying region by selective irradiation by means of the at least one energy beam if the layer has at least the predetermined minimum temperature in the inspection region. Therein, the invention is based on the realization that only those regions of the powder bed should be irradiated for high process reliability, which reach or have reached at least a predefined minimum or set temperature (approved inspection region or approval region) before and/or during the irradiation. However, a sub-region of the layer heated at least to the minimum or set temperature at a certain point of time usually only occupies a relatively small portion of the overall area of a construction field or of the component layer to be produced. Considering the different speeds of “heating” and “irradiation”, therefore, the layer can first be subdivided into two or more virtual sub-regions or segments by means of the control device according to the invention. Hereto, the control device can generally comprise a processor device, which is configured to control and regulate the performance of the mentioned method steps, respectively. Hereto, the processor device can comprise at least one microprocessor and/or at least one microcontroller. Furthermore, the control device can comprise a storage medium with a program code, which is configured to perform the mentioned method steps upon execution by the control device. The program code can be stored in a data storage of the processor device. In addition, the control device can comprise a storage medium with a program code, which is configured to execute an embodiment of the method according to the first inventive aspect. The virtual sub-regions and thereby also their corresponding real sub-regions can, but do not compulsorily have to be geometrically contiguous, and can, but do not compulsorily have to contain the component layer to be produced, respectively, but can also characterize regions of the layer, which for example belong to support structures or to other components. Furthermore, each virtual sub-region can basically be locally and/or temporally predetermined or dynamically ascertained by the control device, for example considering current construction data. Therein, a sub-region can basically correspond to a defined irradiation region and/or a cross-sectional area of a component and/or a partial area of an entire construction field. Due to the irradiation speed usually higher with respect to the heating, it can be provided that the real sub-regions, which are to reach or exceed the requested minimum temperature at the same time or one after the other, are several or multiple times larger than an area of the energy beam since an irradiation procedure otherwise is only possible severely slowed or has to be interrupted each time an approved sub-region is solidified. Subsequently, the control device selects a first virtual sub-region and starts tempering a heating region in the real sub-region of the layer corresponding to the virtual sub-region with the aid of the heating device. The irradiation of the concerned real sub-region is only approved by the control device if at least one inspection region, which can be identical to or deviating from the sub-region, has reached the requested minimum temperature. The inspection region is inspected by the inspection device, which generally includes a temperature measuring device or is coupled to a temperature measuring device, with respect to its temperature and reaching the minimum temperature. Therein, it can basically also be provided that the sub-region is heated above the minimum temperature in the heating region to better consider possible thermal conducting and cooling effects between the steps of “heating” and “solidifying”. Similarly, it can be provided that identical or different maximum temperatures are predetermined or dynamically ascertained for some or all sub-regions, such that a temperature sufficient for approval of the irradiation can be between the minimum temperature and a maximum temperature. By these interaction and coordination of the steps of “heating” and “irradiating”, respectively, therefore, it is possible despite of the limiting factor “speed of the displacement of a heating region”, to process-reliably solidify a component layer in a time as short as possible and as continuously as possible, whereby a correspondingly high component quality is achieved. Further features and the advantages thereof result from the description of the first inventive aspect, wherein advantageous configurations of the first inventive aspect are to be regarded as advantageous configurations of the second inventive aspect and vice versa.

In an advantageous configuration of the invention, it is provided that the heating device is formed as an induction heating device and comprises at least one induction coil for locally heating the layer. Hereby, a local inductive heating adapted to the geometry of the component layer to be produced is possible such that the likelihood of hot crack formations in the production can be severely reduced in particular in using high-temperature alloys as the component material. Basically, the heating device can also comprise two or more inductors for inductively tempering presettable regions of the layer. Two inductors can for example be oriented perpendicularly to each other, wherein the first inductor can engage with the second inductor in an operating position (“cross-coil concept”) in further configuration. Therein, the maximum temperature in the heating region is typically only reached in the environment and in a metal powder-based additive production process typically below a region, respectively, at which the inductors are immediately one above the other and their effective ranges superimpose each other, respectively. According to an alternative configuration, a large induction coil arm encompasses a smaller induction coil arm, wherein the smaller one can move in a plane parallel to the construction field e.g. along a longitudinal extension of the large induction coil arm. In this example too, the maximum temperature of heating can only be achieved in cooperation of the two inductors, namely by means of a superposition of both induction fields. However, it is to be emphasized that the heating device is not restricted to a certain configuration of the induction heating device.

A third aspect of the invention relates to a storage medium with a program code, which is formed to control a device according to the second inventive aspect upon execution by a control device such that it performs a method according to the first inventive aspect. The features arising herefrom and the advantages thereof can be taken from the descriptions of the first and the second inventive aspect, wherein advantageous configurations of the first and the second inventive aspect are to be regarded as advantageous configurations of the third inventive aspect and vice versa.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not comprise all of the features of an originally formulated independent claim. Moreover, implementations and feature combinations are to be considered as disclosed, in particular by the implementations set out above, which extend beyond or deviate from the feature combinations set out in the relations of the claims. There shows:

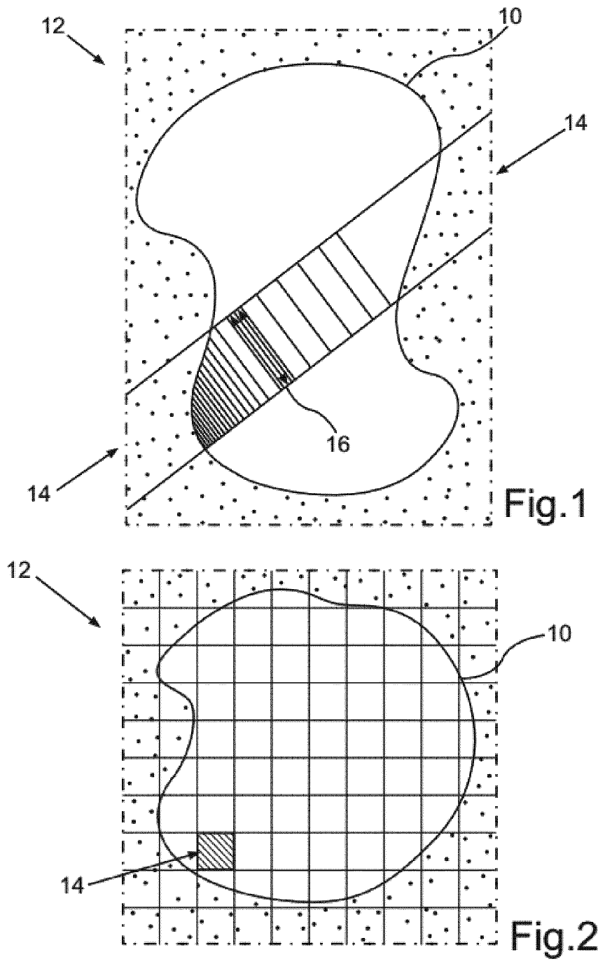

FIG. 1 a schematic view of a component layer, which is generatively produced by locally solidifying a layer;

FIG. 2 a schematic view of a further component layer, which is generatively produced by locally solidifying a layer;

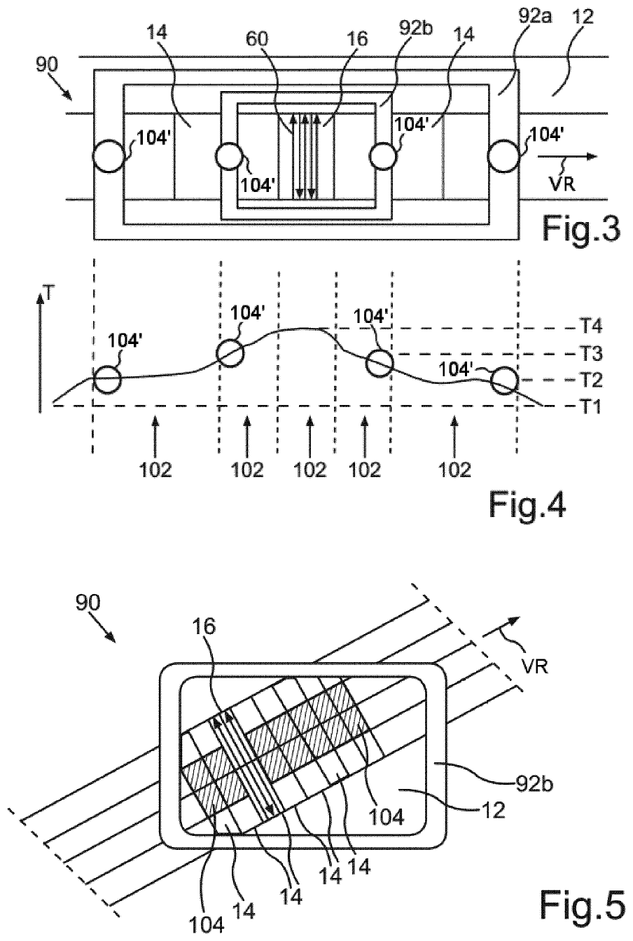

FIG. 3 a schematic top view of a local heating device with two induction coils, which are arranged parallel to a solidification progress direction in their longitudinal extension;

FIG. 4 a diagram of a resulting temperature progression in a powder and component layer, respectively, located below the heating device shown in FIG. 3;

FIG. 5 a schematic top view of the local heating device, wherein an induction coil is arranged obliquely to a solidification progress direction in its longitudinal extension;

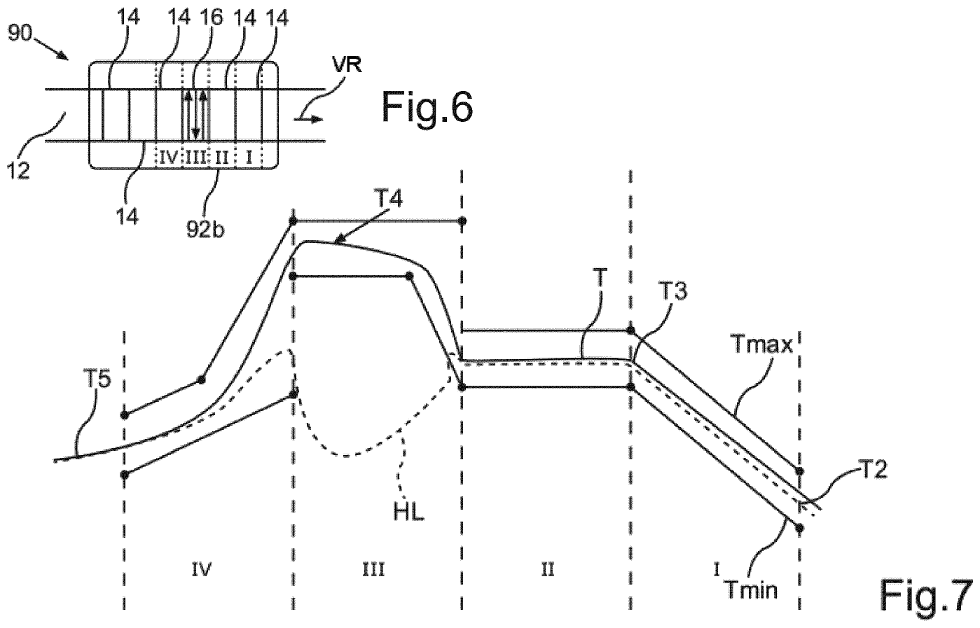

FIG. 6 a schematic top view of the local heating device with multiple associated heating regions;

FIG. 7 a diagram of a heating control of the heating device shown in FIG. 6 and a resulting temperature progression in the powder and component layer, respectively;

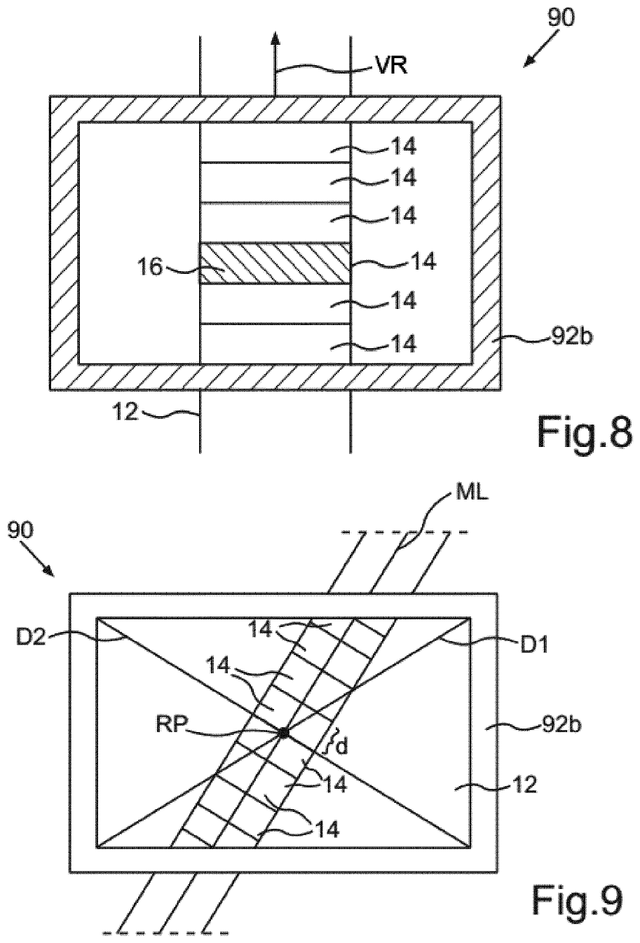

FIG. 8 a schematic top view of the local heating device, wherein an induction coil is arranged perpendicularly to strip-shaped arranged sub-regions in its longitudinal extension;

FIG. 9 a schematic top view of the local heating device, wherein an induction coil is oriented with respect to the sub-regions based on a reference location;

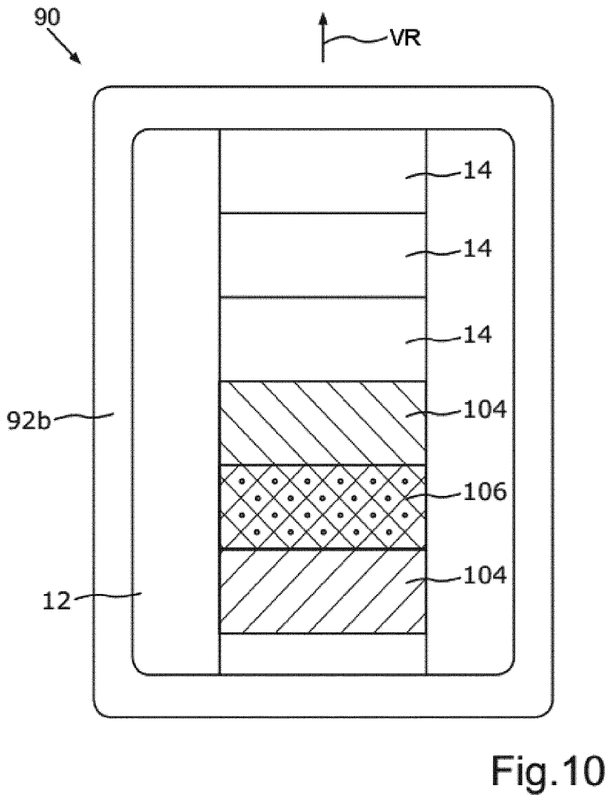

FIG. 10 a schematic top view of the local heating device, wherein procedurally consecutive inspection regions overlap with each other; and

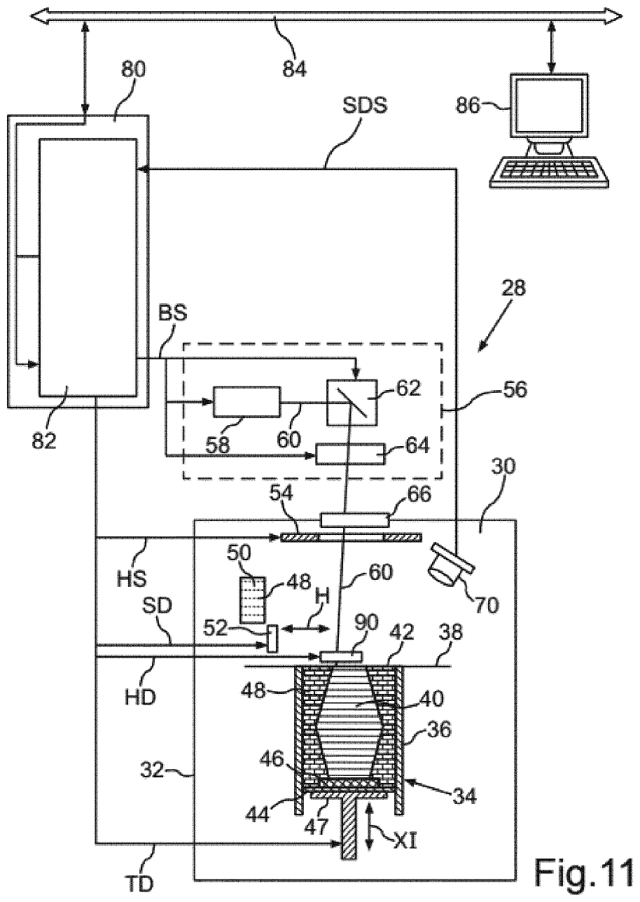

FIG. 11 a schematic diagram of an embodiment of a device according to the invention.

FIG. 1 shows a schematic view of a component layer 10, which is generatively produced by locally solidifying a layer 12. A schematic diagram of an embodiment of a device 28 according to the invention, by means of which a so-called additive and generative manufacturing method, respectively, can be performed, is illustrated in FIG. 11. FIG. 1 will be explained in synopsis with FIG. 11 in the following.

Therein, a component 40, which can for example be a component 40 of a fluid kinetic machine or an aircraft engine, is structured in layers. Predominantly metallic components 40 can for example be produced by laser and electron beam melting or sintering methods, respectively. Therein, at least one powdery component material 48 is first applied in layers in the region of a construction field or a structuring and joining zone 42 to form the layer 12. Subsequently, the component material 48 is locally solidified by supplying energy to the component material 48 by means of at least one energy beam in the region of the structuring and joining zone 42, whereby the component material 48 melts or sinters and forms the component layer 10. Therein, the energy beam is controlled depending on layer information of the component layer 10 respectively to be produced. The layer information is usually generated from a 3D CAD body of the component 40 and subdivided into individual component layers 10. After solidifying the molten component material, a component platform 46 is lowered by a predefined layer thickness. Thereafter, the mentioned steps are repeated until final completion of the desired component region or the entire component 40. Therein, the component region or the component 40 can basically be produced on the component platform 46 or for example on an already generated part of the component 40, on a support structure or directly on a base plate 44 of the device 28. The advantages of this additive manufacture are in particular in the possibility of being able to produce very complex component geometries with cavities, undercuts and the like within the scope of a single method.

In order to be able to locally heat the component material 48, a heating device 90 is used, by means of which the layer 12 can be heated to a desired minimum temperature in individual heating regions. Therein, the local heating device 90 serves for improving e.g. the mechanical characteristics of a component 40 and for example comprises one or more induction coil(s) 92a, 92b (see FIG. 3) or inductor(s) movable relative to the layer 12. By the local inductive heating for example individually adaptable to the geometry of the component layer 10 to be produced, it is possible that hot crack formations are reliably prevented in the production of the component in particular in using high-temperature alloys as the component material. Since eddy currents cannot be induced in powders, already solidified component layers 10 located below the layer 12 are heated in this case. Initially and in the region of the first component layers 10, respectively, the prefabricated base plate 44 can be captured by the induction field. The heat is then transferred into the layer(s) 12 located above via thermal conduction/thermal radiation.

Therein, an area of the powder bed 12 heatable at least to a minimum or set temperature at an identical point of time, however, only occupies a small portion of a construction field 42 and the component layer 10, respectively. Thus, the heating region of the local heating device 90 usually has to be moved across the construction field 42 in order that the entire component layer 10 can be heated and irradiated. At the same time, however, a scan speed of the energy beam, for example a laser beam 60 or an electron beam, is usually relatively high. An action field of the energy beam can include jumps or large distances on the layer 12, which are traveled in very short time (e.g. in contour exposure, island irradiation strategy). Displacing the heating region (coil assembly) is effected substantially slower in contrast thereto for mechanical and thermal reasons. The interaction of “heating” and “irradiating”—with energy sources 58 such as for instance lasers, one speaks of “exposure”—should therefore be coordinated such that a component layer 10 can be solidified in a time as short as possible and as continuously as possible despite of the limiting factor “speed of the displacement of a heating region”, wherein the process reliability and the maximally achievable component quality always have priority.

Therefore, for high component quality, it should be ensured that only solidifying regions of the layer 12 are irradiated, which reach or have reached at least a predefined minimum or set temperature (“approved inspection region”) during the irradiation. Due to the possible irradiation speed, the solidifying regions, which reach or exceed the minimum or set temperature at the same time, have to be multiple times larger than a laser spot and a location of impingement of a focused solidification beam, respectively, on the surface of the layer 12 in practice, since an irradiation procedure otherwise either would proceed severely slowed or would have to be interrupted each time a solidifying region 16 is completely solidified. Thereby, the maximum area of a solidifying region 16 is substantially determined by the area, in which a minimum or set temperature is achievable at the same time anyway.

In a heating device 90 with a cross-coil arrangement or an arrangement, in which a small induction coil 92b is positioned in a larger induction coil 92a (see FIG. 3), the heating region 102 for example corresponds approximately to the area between the coil arms, in which the effective ranges of the induction coils 92a, 92b superimpose on each other. Since an approved inspection region 104 indicates approval of a subsequent irradiation, a section often has to be subtracted from the mentioned heating region 102 in practice, which is covered by a coil arm arranged above.

A corresponding production method can be differently configured.

### EXAMPLE 1

### Sequential Irradiation

The additive production of the component layer 10 can generally be effected in sequential, stepped and/or successive manner. First, the layer 12 is subdivided into multiple virtual sub-regions 14 based on model data, which are consecutively selected in a preset or dynamically determined order. For example, this can be effected with the aid of the control device 80. Each real sub-region 14 of the layer 12 to be solidified, which corresponds to a corresponding virtual sub-region 14, is then locally heated in a heating region by means of the heating device 90. Subsequently, it is verified in an inspection region 104 by means of an inspection device 70 including a temperature measuring device, if a predetermined minimum temperature has been reached. After reaching the preset minimum temperature, the layer 12 is solidified in a solidifying region 16. The real sub-regions 14, the heating regions 102, the inspection regions 104 and the solidifying regions 16 can, but do not compulsorily have to correspond to identical regions of the layer 12. For example, a heating region 102 can overlap with a virtual/real sub-region 14, for instance if the heating by means of the heating device 90 is not restricted to a clearly limited (real) sub-region 14. However, a heating region 102 can also be a subset of a sub-region 14, for example if the heating occurs exclusively within the (real) sub-region 14. Similarly, an inspection region 104 and/or a solidifying region 16 can also be identical to a (virtual/real) sub-region 14 or overlap with it or represent a subset of the respective sub-region 14. The individual virtual/real sub-regions 14 do not compulsorily have to be geometrically contiguous and either not compulsorily be a constituent of an individual component 40.

After exposure of a sub-region 14, the heating region 102 or the heating device 90 is displaced to another location of the layer 12 and directly or indirectly heats a procedurally following heating region 102 in the procedurally following sub-region 14 to the respectively desired minimum temperature. After reaching the minimum temperature (approved inspection region 104), the further sub-region 14 is solidified in the solidifying region 16 etc. until the component layer 10 is finished.

### EXAMPLE 2

### Continuous Feed of the Energy Beam

In this embodiment, the steps of “heating” and “exposing” or “irradiating” are effected coordinated in time such that irradiation breaks as low as possible occur. In other words, the period of time, in which it is not irradiated, is minimized, e.g. because the heating device 90 first has to move to a target position to heat there a heating region 102 in a subsequent sub-region 14 or because the solidifying region 16 is not (yet) irradiated, because the required minimum temperature has not (yet) been reached in the inspection region 104. Preferably, the irradiation of the entire component layer 10 is effected continuously and without irradiation interruption, respectively. Therein, short irradiation breaks are not understood as irradiation interruption, which e.g. are taken in the typical irradiation pattern of hatching between sweeping or scanning individual lines substantially parallel to each other when a beam deflection unit performs a reversal operation without the beam being activated therein. Hereto, the individual sub-regions 14 can for example be arranged along one or more strip-shaped solidifying regions 16 as it is shown in FIG. 1. In this manner, continuously or largely or quasi-continuously consecutive solidifying regions 16 arise since the layer 12 is locally heated in temporally and locally consecutive heating regions of corresponding sub-regions 14 and is at least largely continuously solidified after reaching the respective minimum temperature.

In FIG. 2, a schematic view of a further component layer 10 is illustrated, which is generatively produced by locally solidifying a layer 12. In contrast to the embodiment shown in FIG. 1, the layer 12 is subdivided in rectangular or square virtual and thereby also real sub-regions 14 in grid-shaped manner. One recognizes that some sub-regions 14 include edge regions of the component layer 10 to be solidified as well as powder regions not to be solidified. Alternatively, the sub-regions 14 can also be defined such that they exclusively include solidifying regions of the layer 12. Similarly, it can generally be provided that some sub-regions 14 do not include solidifying regions, but still are directly or indirectly heated, and/or that some sub-regions 14 comprise solidifying regions, but are not or at least not directly pre-heated by means of the local heating device 90.

Via reaching the minimum or set temperature, sub-regions 14 can be defined, which are not necessarily locally contiguous. The order of the processing of the sub-regions 14 is for example determined by the point of time of reaching the minimum temperature or also the vicinity of the actual temperature to a respective set or minimum temperature and is effected preferably temporally to the approval of the respective sub-region 14 (triggering of the approval by reaching the minimum temperature). Therein, the geometrically continuous irradiation can also be interrupted if it allows a more advantageous irradiation and solidification, respectively, or if the geometric data of the component layer 10 to be produced makes this required. It should always be the goal to achieve a solidification as continuous as possible, that is a break portion as low as possible of the overall duration of the exposure of the layer 12 per component layer 10 to be produced.

For heating the layer 12 preferably low in interruptions or without interruption, therefore, the movement of the heating spot of the heating device 90 is preferably coupled to the direction and speed, respectively, of the irradiation progress to achieve “travel paths” of the heating device 90 as efficient as possible with regard to the overall area of the component layer 10 to be irradiated depending on the used heating method and induction coil arrangement, respectively. Due to the relative inertia of the heating device 90, long paths without heating activity are generally to be avoided as possible.

In terms of control, these goals are achieved by the already described segmentation or subdivision of the layer 12 into virtual and real sub-regions 14 and the mechanism of heating, verifying the temperature and the approval of the individual sub-regions 14 for the solidification upon reaching the respective minimum temperature. A sub-region 14 or a solidifying region 16 can for example be locally defined via
a defined irradiation region; and/or
a cross-sectional area of the component 40 to be produced; and/or
a geometry of the component layer 10 to be produced; and/or
a geometry of the entire construction field 42.

Alternatively or additionally, a sub-region 14 or a solidifying region 16 can for example be temporally defined:
dynamically during the construction process; and/or
as a pre-calculation or predetermined.

Other criteria, which can be incorporated individually and in any combination into the determination of the number and configuration of the individual regions (virtual/real sub-region 14, heating region, inspection region, solidifying region), for example include the ascertainment of suitable minimum values with respect to the surface area of a sub-region 14 and/or the simulated irradiation duration of a sub-region 14 and/or the length of an irradiation path located in a sub-region 14 or in a solidifying region 16. Furthermore, segmentation or subdivision of the component layer 10 can be effected in multiple stages such that multiple segments or sub-regions 14 are for example combined to clusters. Each cluster can then be irradiated e.g. with different irradiation types. For example, a sub-region 14 or cluster of sub-regions 14 or solidifying regions can be irradiated with the alternative irradiation type “checkerboard pattern” or another suitable pattern instead of the irradiation type “strip pattern”, to for example avoid local overheatings in particularly sensitive regions like tapered regions or contour regions.

As further variants of implementation, regions (sub-regions 14, heating regions 102, inspection regions 104, solidifying regions 16) arranged overlapping with each other can be provided. Similarly, it can be provided that individual, multiple or all regions (sub-regions 14, heating regions 102, inspection regions 104, solidifying regions 16) are differently determined depending on the method state, thus for example with smaller area before the solidification and with larger area after the solidification or vice versa. Thus, an unilateral or mutual dependency between the movement path of the heating device 90 and the movement path of the energy path is basically taken into account for the control and/or regulation of the device 28.

In the following embodiments, the real sub-regions 14 and the solidifying regions 16 are usually identically selected. The heating regions 102 are selected such that each sub-region 14 is overall heated at least to its respectively requested minimum temperature, wherein it is not excluded that adjoining sub-regions 14 are optionally co-heated, but without therein having to reach the minimum temperature requested for them. In the following embodiments, the inspection regions 104 are subsets of the respective sub-regions 14 such that the momentary temperature and reaching the minimum temperature, respectively, are respectively not verified in the entire sub-region 14. Instead, the temperature in the section of the associated sub-region 14 located outside of the inspection region 104 is inferred with the aid of empirical values, extrapolation or the like based on the temperature in the inspection region 104. This principle can basically be applied within the scope of the present disclosure without being restricted to the following embodiments.

In an embodiment, the heating, verifying and solidifying step of n sub-regions 14 (X₁ . . . Xₙ) of a component layer 10 can be statically effected and include the following steps of:
subdividing model data of the layer 12 or the construction field 42 into virtual sub-regions;
selecting a first virtual sub-region and associating a real sub-region 14 (segment X₁);
control: heating the first sub-region 14 (segment X₁) (variable or optionally max. heating power HL) in a corresponding heating region 102;
inspection: set or minimum temperature reached in the inspection region 104 for sub-region 14 (X₁)?
If yes: signal “approval for irradiation”; if no: signal: “continue heating”, optionally with changed heating rate and heating power HL, respectively;
control: with active approval, continuous heating (optionally with changed heating rate and heating power HL, respectively) or aborting heating of the sub-region 14;
control: exposure of the sub-region 14 (X₁);
optionally signal: approval for deactivation of the heating of the heating region 102 of the associated sub-region 14 (X₁) (immediately or with temporal offset, e.g. due to an advantageous thermal post-treatment);
optionally signal: final approval of the sub-region 14 (X₁) after deactivation of heating;
control: displacing the heating region (optionally max. heating level) for heating the procedurally following sub-region 14 (X₂) and performing the process in analogous manner for all of the remaining sub-regions 14 (X₂ . . . Xₙ) of the component layer 10.

In alternative embodiments, the heating, verifying and solidifying step of the sub-regions 14 (X₁ . . . Xₙ) of a component layer 10 can be dynamically effected and include the following steps and embodiments individually or in any combination:
setting a required minimum number or a minimum pre-run and/or a maximum number or a minimum post-run of heating relative to the location of impingement of the energy beam; the definition of “minimum number/minimum pre-run” and “maximum number/minimum post-run”, respectively, can be effected e.g. according to the following criteria:
based on time (heating/irradiation);
length of an irradiation path in an approved sub-region 14 with reached minimum temperature;
number of sub-regions 14 (included in pre-heating; approved for exposure; already exposed, etc.).

From a minimum pre-run of approved heated sub-regions 14, the irradiation and solidification of the component layer 10 starts, respectively. After effected approval of a sub-region 14 (heating terminated and optionally solidification terminated), the heating region is displaced to the next sub-region 14 to be solidified. With sufficiently large buffer, a permanent movement of the energy beam, optionally with acceleration and deceleration phases, can thereby be achieved. Successively heated sub-regions 14 can be displayed as segments approved for irradiation in a display device to provide the corresponding information to a user. An irradiation of the respective component layer 10 is effected continuously and largely uninterrupted as possible, respectively. The buffer of heated and approved sub-regions 14 is preferably adjusted such that it is not consumed until the irradiation of the entire component layer 10 is terminated. Hereto, it can be required that procedurally later sub-regions 14 are differently heated than procedurally earlier sub-regions 14 to provide a heat buffer for compensation for the cooling to be expected up to the beginning of the respective irradiation. Therein, it has generally proven advantageous if a maximum temperature, which can be identically or differently predetermined or dynamically ascertained for different sub-regions 14, is not exceeded to prevent “burning” of the component material or new fusing of already solidified component layers 10.

The movement of the comparatively narrow effective range of the heating device 90 (coverage of the small induction coil 92b) can be adjusted corresponding to an averaged movement direction of an energy beam, wherein the movement of the energy beam is usually effected perpendicularly or at an angle of at least 45°, that is of 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89° or 90° to the movement direction of the heating device 90 on the layer 12. Therein, irradiation jumps are to be reduced or to be avoided as far as possible, which overstrain a displacement speed of the heating device 90 to prevent that a buffer of tempered sub-regions 14 is consumed in the meantime and a continuous irradiation of the entire layer 12 is interrupted.

### EXAMPLE 3

According to a further embodiment, a ratio of “minimum pre-run:minimum post-run” is set between 1.5:1 and 3:1, thus for example 1:5:1, 1.6:1, 1.7:1, 1.8:1, 1.9:1, 2.0:1, 2.1:1, 2.2:1, 2.3:1, 2.4:1, 2.5:1, 2.6:1, 2.7:1, 2.8:1 2.9:1 or 3:1.

### EXAMPLE 4

A minimum number of sub-regions 14 to be approved for irradiation is set before irradiation of the concerned component layer 10 starts. This offers the advantage that a buffer is provided with the purpose that an irradiation does not have to be terminated after approval of a segment or sub-region 14, but can be immediately continued in a next approved sub-region 14.

### EXAMPLE 5

A maximum number of irradiated and approved sub-regions 14 or segments, respectively, is defined before a heating region of the heating device 90 is displaced. This offers the advantage that a buffer is provided with the purpose that a heating region of the heating device 90 is displaced in time such that a minimum number of approved (i.e. sufficiently heated according to verification) sub-regions 14 is always available.

### EXAMPLE 6

After effected approval (see above) for a segment or a sub-region 14 due to the reached minimum temperature, the heating region of the heating device 90 is displaced, for example by moving an induction coil assembly, namely by a certain distance or segment, such that at least one further sub-region 14 to be irradiated is in a distance and orientation to the heating device 90, respectively, which allow heating to the respectively desired minimum temperature value.

### EXAMPLE 7

An x/y control coordinate is calculated, for example via reference locations of a (e.g. regularly shaped) heating region and a (e.g. regularly shaped) solidifying region, respectively. Therein, various parameters can be taken into account, such as for example the capturing frequency (60 Hz) of an IR camera (inspection device 70), which can be used for temperature measurement of the layer 12, a hatch distance, a width of an irradiation strip or a scan speed of the energy beam. Before the beginning of the irradiation, a buffer of sub-regions 14 approved for irradiation is preferably generated here too.

FIG. 3 shows a schematic top view of a local heating device 90 with a large and a small induction coil 92a, 92b, which are presently arranged parallel to a solidification progress direction VR in their longitudinal extension, that is in an ideal orientation to strip- or band-shaped arranged sub-regions 14. The sub-regions 14 are selected one after the other in solidification progress direction or feed direction VR, heated, inspected and solidified after reaching the predetermined minimum temperature. In the following, FIG. 3 will be discussed in synopsis with FIG. 4, which shows a diagram of a resulting temperature progression in a layer 12 located below the heating device 90 shown in FIG. 3. One recognizes that the solidifying region 16 is presently selected congruent or identical with one of the sub-regions 14, while the heating regions 102 are not congruent with the sub-regions 14. As one recognizes in FIG. 4, a multi-step temperature progression arises along the extension of the heating device 90 from left to right, that is viewed in the direction of the feed direction VR. The initial temperature is a base temperature T1, which prevails in the process chamber 30 and can for example be generated by the radiation heating 54 shown in FIG. 11 or also only by the ambient temperature. It is basically variable and can increase e.g. over a construction or production operation. Starting from the base temperature T1, the temperature increases first to a temperature T2 by the induction effect of the large coil 92a. By the superposition with the eddy currents induced by the small induction coil 92b, the temperature increases in a component platform 46 and an already selectively solidified layer below the layer 12, respectively, and thereby per thermal transfer also the temperature of the layer 12 itself over a ramp to the temperature T3 located slightly below the melting temperature of the component material, which presently represents the desired minimum temperature (Tmin) for the solidification at the same time. By the exposure paths of the laser beam 60 symbolized by arrows, the temperature of the layer 12 in the currently processed solidifying region 16 is increased to a temperature T4 located above the melting temperature of the component material such that the component material 48 is locally and selectively molten and solidified, respectively, in the concerned sub-region 14 and solidifying region 16, respectively. Subsequently, the temperature falls again back to the value T3 over a ramp in a solidified post-heating region within the effective range of the small induction coil 92b and to the value T2 outside of the small induction coil 92b. After an effective range of the large induction coil 92a has departed from a solidified sub-region 14 by moving the coil 92a, the temperature finally again falls to the ambient temperature T1.

Furthermore, one recognizes in FIG. 3 projection regions 104′ identified with circles in the region of the large and the small induction coil 92a, 92b, in which a direct measurement of the temperature of the layer 12, for example with the aid of a thermal imaging camera or thermography device of the inspection device 70, respectively, is not possible due to the shading by the induction coils 92a, 92b. In FIG. 4, the projection regions 104′ are also identified with circles. In these projection regions 104′, a projection or an estimation based on empirical values replaces the direct ascertainment or measurement of the current temperature.

FIG. 5 shows a schematic top view of the local heating device 90, wherein the induction coils 92a, 92b are arranged obliquely to a solidification progress direction VR according to their longitudinal extension, in which the strip- or band-shaped arranged sub-regions 14 are to be solidified one after the other. For reasons of clarity, only the small induction coil 92b is illustrated. One recognizes that the rectangularly selected sub-regions 14 of the layer 12 are differently severely shaded due to the oblique arrangement of the induction coil 92b related to the progress direction of the solidification process indicated by the arrow VR. Therefore, the inspection regions 104 are presently selected such that they only correspond to a partial area of the respective sub-region 14. For example, each inspection region 104 can be selected or predetermined such that it has only less than 50%, 51%, 52, %, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98% or 99% of the area of the respective sub-region 14. It is understood that all of the inspection regions 104 can basically have identical areas or area portions or individually selected or predetermined areas or area portions. Generally, the inspection regions 104 are of course to be selected such that a meaningful result can be ascertained. Those sections of a sub-region 14, which are not located within an inspection region 104, either cannot be considered for the temperature verification or for example considered by extrapolation or estimation based on empirical values (projection regions 104′).

FIG. 6 shows a schematic top view of the local heating device 90 with multiple associated heating regions 102, wherein only the smaller induction coil 92b is illustrated for reasons or clarity. In the following, FIG. 6 will be explained in synopsis with FIG. 7, in which a diagram of a heating control of the heating device 90 shown in FIG. 6 and a resulting temperature progression in the layer 12 is shown. The control of the heating power HL of the heating device 90 can for example be effected by the control device 80. The heating control is exemplarily shown for four procedurally consecutive sub-regions 14, which are identified by Roman numerals (I-IV) in FIG. 6 and FIG. 7. Therein, the sub-regions 14 identified by I and II can also be referred to as pre-run, while the sub-region 14 identified by IV and further sub-regions 14 within the vision window of the induction coil 92b can be referred to as post-run, whereby a ratio of pre-run to post-run of about 2:3 presently results.

Viewed from right to left, that is opposite to the solidification progress direction VR, pre-heating of the layer 12 is first effected in the region I by means of the small induction coil 92b from a temperature T2, to which the layer 12 was already heated by the large induction coil 92a, to a higher temperature T3, which prevails in the region II. Therein, the temperature curve of the layer 12 ascertained with the aid of the inspection device 70 (actual temperature) is presently identified by the reference character T. In the region III, that is in the approved sub-region 14 and in the solidifying region 16 presently congruent with it, respectively, solidification of the layer 12 is effected by irradiation with an energy beam, whereby the temperature increases from T3 to T4. In the region IV, a post-heating phase is then effected, whereby the temperature decreases to the value T5. As one sees in FIG. 7, the heating power HL, which is immediately coupled to the temperature progression T in the regions I, II and IV, is therein reduced in the region III, that is in the solidifying region 16 to account for the additional energy input by the energy beam. Hereby, it is ensured that the actual temperature T of the layer 12 always ranges in a predetermined temperature band, which can be defined by a predetermined minimum temperature Tmin and a predetermined maximum temperature Tmax. This represents a particularly process-reliable solidification of the layer 12 and a correspondingly high-quality component layer 10, since sufficient pre-heating of the component material 48 is ensured on the one hand and an inadmissible heating of the component material 48 is prevented on the other hand. Since the solidifying region 16 possibly cannot be monitored by thermography depending on the respectively used inspection device 70, the control and regulation of the heating power HL, respectively, are for example effected by extrapolation, calculation and/or based on empirical values.

FIG. 8 shows a schematic top view of the local heating device 90, wherein the small induction coil 92b is oriented perpendicularly to a solidification progress direction VR of the strip- or band-shaped arranged sub-regions 14 according to its longitudinal extension. The strip- or band-shaped arranged sub-regions 14 thereby formally form a segmented exposure strip. In FIG. 8 too, the large induction coil 92a is not illustrated for reasons of clarity. One recognizes that related to the solidification progress direction VR, a ratio of pre-run:post-run is presently 3:2. It is understood that other ratios can basically also be adjusted by corresponding dimensioning of the induction coils 92a, 92b and/or the sub-regions 14. For example, a ratio of pre-run:post-run can be 4:3.

FIG. 9 shows a schematic top view of the local heating device 90, wherein the small induction coil 92b is oriented with respect to the sub-regions 14 based on a reference location RP. Hereto, a central point of the vision region of the induction coil 92b is first ascertained, for example via the point of intersection of the diagonals D1, D2 and correlated with a global coordinate system of the process chamber 30 with the aid of the control device 80. Furthermore, a central line ML of the sub-regions 14 arranged along an exposure strip is ascertained in the vision region of the induction coil 92b. Therein, the sub-regions 14 are rectangularly formed in the present example and each have the same distance d and the same dimensions, respectively. By referencing the central line ML and the central point to each other, the reference location RP is ascertained, with the aid of which the respective solidifying region 16, the respective pre-run and post-run of sub-regions 14 and/or the respective inspection regions 104 can be determined. For example, a perpendicular can be formally dropped by the reference location RP, which is then perpendicular to a given orientation of strip-shaped arranged sub-regions 14. Parallels to the perpendicular then define boundaries of the associated inspection regions 104 or sub-regions 14.

FIG. 10 shows a schematic top view of the local heating device 90, only the small induction coil 92b of which is again illustrated. Furthermore, multiple sub-regions 14 are illustrated, which are again strip- or band-shaped arranged in the solidification direction X. One recognizes that the two exemplarily shown inspection regions 104 procedurally evaluated one after the other or at the same time are selected not identically with their respective sub-regions 14 on the one hand and overlap with each other in an overlap region 106 on the other hand. The overlap is presently 50%, wherein deviating values above or below 50% can basically also be provided. Furthermore, more than two inspection regions 104 can basically also overlap with each other. An overlap of inspection regions 104 is generally reasonable if the inspection regions 104 represent a relatively large area of the layer 12 and a relatively large portion of the vision region of the small induction coil 92b, respectively.

FIG. 11 shows a schematic diagram of an embodiment of a device 28 according to the invention. The preceding embodiments can be performed with the aid of such a correspondingly configured device 28, wherein the device 28 is presently formed as a laser sintering or laser melting device for additive manufacture of components 40. It is explicitly pointed out that the invention is not restricted to laser sintering or laser melting devices such that the device 28 can for example also be formed as an electron beam sintering or melting device. In the following, the device 28 is therefore also referred to as “laser sintering device”—without restriction of generality.

The device 28 comprises a process chamber 30 or a process space 30 with a chamber wall 32, in which the manufacturing process substantially proceeds. A container 34 open to the top with a container wall 36 is located in the process chamber 30. The upper opening of the container 34 forms the respectively current work plane 38. The region of this work plane 38 located within the opening of the container 34 can be used for structuring the component 40 and is therefore referred to as construction field 42 or as structuring and joining zone. Usually, it is sufficient if the process space sensor data SDS and the model data used within the scope of the invention respectively relate to the region of the process space 30 defined by the construction field 42 (i.e. in the work plane), optionally also a part thereof.

The container 34 comprises a base plate 44 movable in a vertical direction XI, which is arranged on a support 47. This base plate 44 terminates the container 34 to the bottom and thereby forms its bottom. The base plate 44 can be formed integrally with the support 47, but it can also be a plate formed separately from the support 47 and attached to the support 47 or simply supported on it. According to the type of the component material 48 used as a structuring material and the manufacturing process, a component platform 46 can be mounted on the base plate 44 as a construction base, on which the component 40 is structured. However, the component 40 can basically also be structured on the base plate 44 itself, which then forms the component platform 46.

The basic construction of the component 40 is effected such that a layer of the powdery component material 48 or structuring material is first applied to the component platform 46, then—as explained later—the component material 48 is selectively solidified with a laser beam 60 at the locations, which are to form parts of the component 40 to be manufactured, then the base plate 44 and thus the component platform 46 is lowered with the aid of the support 47 and a new layer of the component material 48 is applied and then selectively solidified. These steps are repeated until completion of the component segment or a complete component 40. The component 40 structured in the container 34 on the component platform 46 is presently illustrated below the work plane 38 in an intermediate state. It already comprises multiple solidified layers, surrounded by component material 48 left non-solidified. Various materials can be used as the component material 48, preferably powders, in particular metal-based powders with a metal or metal alloy content of at least 50% by vol. or also filled or mixed powders.

Fresh component material 48 is located in a storage container 50 of the laser sintering device 28. With the aid of a coater 52 movable in a horizontal direction H, the component material 48 can be applied in the form of a thin layer 12 in the work plane 38 and within the construction field 42, respectively.

A basically optional radiation heating 54 is located in the process chamber 30. It can serve for globally heating the applied component material 48 such that an additionally used locally acting heating device 90 can input a lower amount of energy. That is, an amount of basic energy can already be input into the component material 48 for example with the aid of the radiation heating 54, which is of course still below the required energy, at which the component material 48 sinters or even melts. For example, an infrared radiator can be used as the radiation heating 54.

For selectively solidifying, the laser sintering device 28 comprises an irradiation device 56 or an exposure device 56 in the example described here with an energy source 58 formed as a laser. This laser 58 generates the laser beam 60, which is deflected via a deflection device 62 to thus sweep the exposure paths or tracks provided according to the exposure strategy in the layer respectively selectively to be solidified and to selectively input the energy. Further, this laser beam 60 is focused to the work plane 38 in suitable manner by a focusing device 64. Here, the irradiation device 56 is preferably located outside of the process chamber 30 and the laser beam 60 is directed into the process chamber 30 via a coupling window 66 attached to the top side of the process chamber 30 in the chamber wall 32.

The irradiation device 56 can for example include not only one, but multiple lasers 58 and laser beams 60, respectively. Preferably, they can be gas or solid state lasers. Alternatively or additionally, one or more electron beam sources are basically also conceivable as the irradiation device 56.

The laser sintering device 28 furthermore contains a sensor assembly or inspection device 70, which is suitable to capture a process radiation emitted during impingement of the laser beam 60 on the component material 48 in the work plane 38 and to determine a measurement value characterizing the temperature in the work plane 38. Therein, this inspection device 70 works locally resolved, i.e. it is presently capable of capturing a type of emission image of the respective layer. Preferably, the inspection device 70 includes a camera, for example a thermography camera, which is sufficiently sensitive in the range of the emitted radiation. Alternatively or additionally, one or more sensors for capturing an optical and/or thermal process radiation could also be used, e.g. photodiodes, which capture the electromagnetic radiation emitted by the impinging laser beam 60, or temperature sensors for capturing an emitted thermal radiation. An association of the signal of a sensor not locally resolving itself with the coordinates would be possible in that the coordinates used for controlling the laser beam 60 are respectively temporally associated with the sensor signal. Presently, the inspection device 70 is arranged within the process chamber 30. However, it could also be located outside of the process chamber 30 and then capture the process radiation through a further window in the process chamber 30 or chamber wall 32.

Here, the signals captured by the inspection device 70 are passed to a control device 80 of the device 28 as process space sensor dataset SDS, which also serves to control the various components of the device 28 for overall control of the additive manufacturing process and which is configured to execute at least one embodiment of the method according to the invention. Hereto, the control device 80 comprises a processor device 82, which usually controls the components of the irradiation device 56, namely here the laser 58, the deflection device 62 and the focusing device 64, and hereto correspondingly passes irradiation control data BS to them.

The control device 80 also controls and regulates, respectively, the radiation heating 54 by means of suitable warming control data HS, the coater 52 by means of coating control data SD and the movement of the component platform 46 in the direction XI by means of support control data TD. Furthermore, the control device 80 controls and regulates, respectively, the heating device 90 by means of heating data HD, by means of which heating regions 102 in the structuring and joining zone 42 can be locally heated. For example, the heating device 90 can be formed as an induction heating as shown in FIG. 3 and comprise an assembly of a large induction coil 92a as well as a small induction coil 92b movable across the construction field 42, wherein the small induction coil 92b is additionally movable within the large induction coil 92a, such that the two induction fields can be selectively superimposed. However, other configurations of the local heating device 90 are also conceivable.

Here, the control device 80 is coupled to a computer device 86 with a display or another human-machine interface e.g. via a bus system 84 or another wired and/or wireless data link for data exchange. An operator can control and/or regulate the control device 80 and thus the entire device 28 via this computer device 86. In particular, the process space sensor dataset SDS can also be suitably visualized on the display of the computer device 86.

At this place, it is again pointed out that the present invention is not restricted to a device 28 formed as a laser melting and/or laser sintering equipment and a device 28 for performing a laser melting and/or sintering method, respectively. It can be applied to any other methods for generative and additive production of a three-dimensional component, respectively, by applying and selectively solidifying a component material 48 in particular in layers, wherein an energy beam is emitted to the component material 48 to be solidified for solidification. Accordingly, the irradiation device 56 either cannot only be a laser 58 as described here, but each device could be used, by which energy can be selectively brought on and into the component material 48, respectively, as wave and/or particle radiation. For example, another light source, an electron beam etc. could be used instead of a laser.

Even if only a single component 40 is illustrated in FIG. 10, it is possible and normally also usual to produce multiple components 40 in the process chamber 30 and in the container 34, respectively, during a construction operation, i.e. within a similar period of time.

In summary, various additive production variants can be performed and corresponding advantages with regard to process reliability and component quality of a correspondingly produced component layer 10 and of a complete component 40, respectively, can be achieved with the aid of the method according to the invention and with the aid of the device 28 according to the invention, respectively, which is configured for performing such a method. Thereby, the invention provides a simple and effective solution of the problem of matching of continuous heating and continuous irradiation of potentially irregular areas, which combines the goals of a reliable and fast performance of the process and allows the additive production of component layers 10 with maximum layer quality.

The parameter values indicated in the documents for the definition of process and measurement conditions for the characterization of specific characteristics of the inventive subject matter are to be considered as encompassed by the scope of the invention also within the scope of deviations—for example due to measurement errors, system errors, DIN tolerances and the like.

### LIST OF REFERENCE CHARACTERS

10 component layer

12 layer

14 sub-region

16 solidifying region

28 device

30 process chamber

32 chamber wall

34 container

36 container wall

38 work plane

40 component

42 structuring and joining zone

44 base plate

46 component platform

47 support

48 component material

50 storage container

52 coater

54 radiation heating

56 irradiation device

58 energy source

60 laser beam

62 deflection device

64 focusing device

66 coupling window

70 inspection device

80 control device

82 processor device

84 bus system

86 computer device

90 heating device

92a induction coil

92b induction coil

102 heating region

104 inspection region

104′ projection region

106 overlap region

HL heating power

SDS sensor dataset

SD coating control data

HD heating control data

BS irradiation control data

HS warming control data

TD support control data

RP reference location

VR solidification progress direction

d distance and dimension of the sub-region 14, respectively

D1, D2 diagonal

H movement direction of the coater 52

ML central line

T1, T2, T3, T4, T5 temperature

Tmin minimum temperature

Tmax maximum temperature

T temperature progression

I, II, III, IV region

XI movement direction of the base plate 44

1. A method for additive production of at least one component layer of a component comprising the steps of:
a) generating at least one layer from a powdery component material in the region of a structuring and joining zone;
b) subdividing model data of the layer into virtual sub-regions by a control device;
c) selecting at least one of the virtual sub-regions by the control device;
d) locally heating at least one heating region in a real sub-region of the layer corresponding to the selected virtual sub-region by a heating device;
e) verifying if a temperature of the layer has a predetermined minimum temperature at least in a predetermined inspection region; and
f) locally solidifying the layer at least in a predetermined solidifying region by selectively irradiating by at least one energy beam of an energy source if the layer has at least the predetermined minimum temperature in the inspection region.

2. The method according to claim 1,
wherein the heating device selectively heats a partial volume of an overall volume of the powdery component material in a construction container to the predetermined minimum temperature at a point of time, wherein the partial volume includes at least 0.01%, and/or at most 50% of a surface area of a work plane in the structuring and joining zone.

3. The method according to claim 1,
wherein at least two regions of the group of real sub-region, heating region, inspection region and solidifying region are at least substantially identically selected and/or that at least one region of the group of real sub-region, heating region, inspection region and solidifying region is a subset and/or an intersecting set of another region of this group and/or that at least two procedurally consecutive regions of the group of real sub-region, heating region, inspection region and solidifying region overlap with each other.

4. The method according to claim 1,
wherein at least the steps c) to f) are performed for two or more sub-regions of the layer to be solidified.

5. The method according to claim 1,
wherein at least one of the steps c) to e) is performed during step f) for at least one further sub-region.

6. The method according to claim 5,
wherein the layer is heated in the heating region of the further sub-region such that the heating region of the further sub-region has at least the predetermined minimum temperature as soon as the irradiation of the preceding sub-region is completed.

7. The method according to claim 1,
wherein step f) is only performed for the first time for the layer if at least a predetermined minimum number of sub-regions has been selected and the associated heating regions have been heated to their respectively predetermined minimum temperature.

8. The method according to claim 1,
wherein at least one further sub-region is selected by the control device and the heating region associated with the further sub-region is heated by the heating device if a predetermined maximum number of solidified sub-regions and/or sub-regions heated to their respectively predetermined minimum temperature has been reached or exceeded.

9. The method according to claim 1,
wherein the control device controls and/or regulates the heating device and the energy source depending on each other.

10. The method according to claim 1,
wherein the solidifying region is heated during and/or after step f) by the heating device and/or that the heating of the solidifying region by the heating device before, during or after step f) is aborted or reduced with respect to heating in step d).

11. The method according to claim 1,
wherein a predetermined minimum temperature and/or a predetermined maximum temperature or a predetermined temperature progression is selected for a number of inspection regions and/or solidifying regions respectively depending on an area and/or a geometry and/or a sought microstructure of a component cross-section or section of the component cross-section to be solidified or being solidified, wherein the minimum temperature and/or the maximum temperature and/or the temperature progression is preferably separately set for each inspection region and/or solidifying region.

12. The method according to claim 1,
wherein the control device controls and/or regulates the heating device such that an already locally solidified sub-region has at least a predetermined minimum temperature and/or has at most a predetermined maximum temperature.

13. The method according to claim 1,
wherein a relative movement of the heating region of the heating device and of the solidified sub-region is effected by a distance and/or in a direction, by which the sub-region leaves a maximum effective range of the heating device, which allows heating the sub-region to a temperature value of at least 1000° C. and/or of at least 70% of the melting temperature in ° C. of the currently used component material, depending on a positive verification to the effect if the temperature of at least a predetermined section of the solidified sub-region corresponds to the preset temperature progression and/or at most to the predetermined maximum temperature.

14. A device for additive production of at least one component layer of a component, comprising:
at least one coater for generating at least one layer from a powdery component material in the region of a structuring and joining zone;
at least one energy source for generating at least one energy beam, by which the layer can be solidified locally to the component layer in the region of the structuring and joining zone;
at least one heating device), which the layer can be locally heated; and
at least one inspection device, by which a temperature of the layer can be verified;
a control device, which is configured to subdivide model data of the structuring and joining zone into virtual sub-regions, to select at least one of the virtual sub-regions, to locally heat at least one heating region in a real sub-region of the layer corresponding to the selected virtual sub-region by the heating device, to verify by the inspection device if a temperature of the layer has a predetermined minimum temperature at least in a predetermined inspection region, and to locally solidify the layer at least in a predetermined solidifying region by selectively irradiating by the at least one energy beam if the layer has at least the predetermined minimum temperature in the inspection region.

15. The device of claim 14, further comprising a storage medium with program code, which is configured and arranged to control the device upon execution by the control device.
